(19) United States
(12) Patent Application Publication
(10) Pub. No.: US 2003/0177820 A1
(43) Pub. Date: Sep. 25, 2003

(54) Vacuum source diagnostic tool for motor vehicles

(76) Inventor: Bruce Allen Klamm, Union Grove, WI (US)

Correspondence Address: BRUCE ALLEN KLAMM, 17813 DURAND AVE, UNION GROVE, WI, 53182, US

(21) Appl. No.: 10/105,673

(22) Filed: Mar. 25, 2002

(51) Int. Cl. G01L 3/26

(52) U.S. Cl. 73/118.1

(57) ABSTRACT

A main control valve (nozzle) (12) a quick disconnect male fitting (14) an operator lever (16) providing variable control of air intake and vacuum, a T adapter (22) with a special venturi (20) press fit inside, a specially designed exhaust tube (46) that enhances the vacuum by creating resistance, Safety relief holes (48) in exhaust tube (46) to prevent positive pressure on gauge (42) an isolation valve (30) a standard T fitting (38) providing an interface to the vacuum gauge (42) and vacuum port (40) consisting of a barbed fitting (44) and a manual lever (32) for opening and closing isolation valve (30).

### CROSS REFERENCE TO RELATED APPLICATIONS

This application is based on provisional application serial No. 27,642, filed on Mar. 27, 2001.

### FEDERALLY SPONSORED RESEARCH

Not Applicable

### DESCRIPTION OF ATTACHED APPENDIX

Not Applicable

### BACKGROUND

1. Field of Invention

The present invention relates to equipment for diagnosing problems in motor vehicles, and more particularly to devices for creating a vacuum which can be applied to specific motor vehicle components (or other non-automotive vacuum operated devices) to simulate operating conditions.

2. Description of Prior Art

Internal combustion engines utilized on motor vehicles often have components which are activated by vacuum produced by other devices on the engine. Sensors are also provided at various places on an engine to measure the vacuum. In the course of diagnosing problems with a motor vehicle, a mechanic often has to simulate the production of the necessary amount of vacuum to artificially activate these components to determine whether they are functioning properly.

Typically, the mechanic utilizes a hand-operated vacuum pump with a fitting connected by a tube to the location on the motor vehicle at which a vacuum is desired. By operating this pump, a partial vacuum is produced at that engine component.

The hand operated pumps have several moving parts and in particular a piston which moves within a cylinder to create the vacuum. A seal is located between the piston and the walls of the cylinder and self operating valves are provided at the inlet and outlet openings of the cylinder.

With use over time, these components wear, thereby reducing the ability of the pump to generate a sufficient level of vacuum to operate the motor vehicle component's. Hand operated pumps are also incapable of providing continuous vacuum for an extended period.

Objects and Advantages

The primary object of the invention is To provide a small handheld apparatus for diagnosing vacuum devices. Several other objects and advantages of the present invention are:

(a) To provide an inexpensive, easy to operate replacement for hand actuated vacuum pumps.

(b) To provide an apparatus for generating vacuum with no moving parts.

(c) To provide an apparatus with longer life span than existing manual pumps.

(d) To provide an apparatus that produces vacuum much faster than present hand actuated pumps for rapid cycle testing of vacuum devices.

(e) To provide an apparatus that produces a more constant and continuous vacuum than hand actuated pumps.

(f) To provide an apparatus that produces a hands free vacuum source by locking the operator lever by means of a thumbscrew clamp, Velcro strip, rubber strap or other temporary or permanent clamping device.

(g) To provide a built in air pressure regulator.

(h) To provide an apparatus that allows you to center attention on the job rather than on operating the device.

Other objects and advantages of the present invention will become apparent from the following descriptions, taken in connection with the accompanying drawings, wherein, by way of illustration and example, an embodiment of the present invention is disclosed.

### SUMMARY

In accordance with a preferred embodiment of the invention, there is disclosed a Vacuum Source Diagnostic Tool for Motor Vehicles comprising: a main control valve (nozzle), a quick disconnect male fitting, an operator lever providing variable control of air intake and vacuum, a T fitting with a venturi tube press fit inside, a specially designed exhaust tube that enhances the vacuum by creating resistance, safety relief holes in exhaust tube to prevent positive pressure on gauge, an isolation valve, a standard T fitting providing an interface to the vacuum gauge and vacuum port, a vacuum gauge, a vacuum port consisting on a barbed fitting, and a manual lever for opening and closing isolation valve.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention

FIG. 2 is a plan view of the invention with thumb screw clamp added

### REFERENCE TO NUMERALS IN DRAWING

12 main control valve (nozzle)

14 inlet with quick disconnect fitting

16 operator lever

18 nozzle outlet

20 venturi

22 T fitting

24 inner passage

26 T fitting outlet

28 vacuum outlet

30 isolation valve

32 operating lever

34 first port of T fitting

36 port for vacuum gauge

38 T fitting

40 third port

42 vacuum gauge

44 barbed fitting

46 exhaust tube

48 safety relief holes

50 thumbscrew clamp

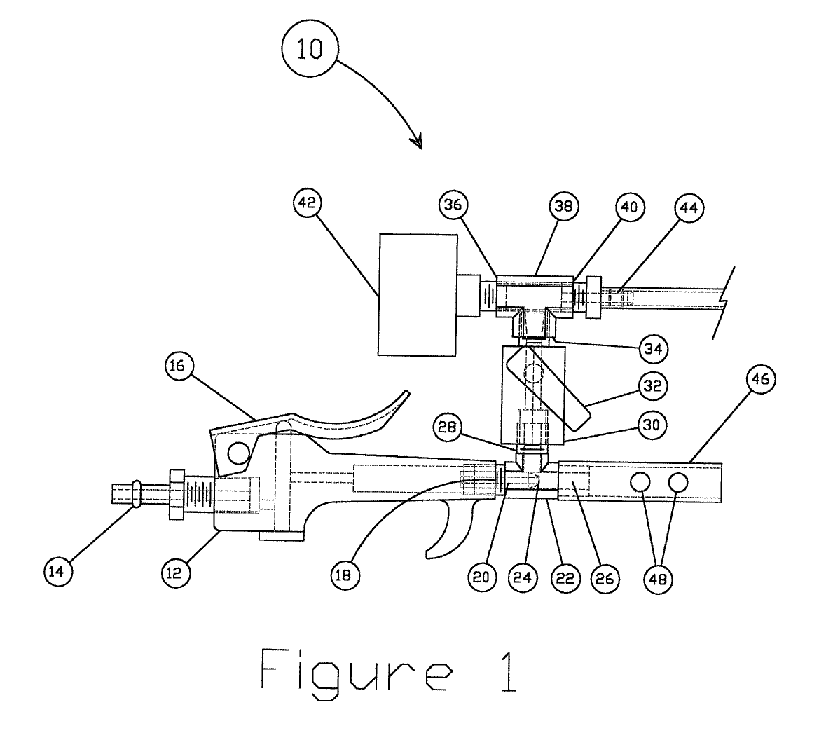

### DETAILED DESCRIPTION—FIG. 1 THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

With reference to the drawing figure, a vacuum source diagnostic tool 10 comprises a main control valve (nozzle) 12 with an inlet that has a quick disconnect fitting 14. The quick disconnect fitting 14 is a male connector of a type commonly used in motor vehicle repair garages to mate with a female connector on the end of a hose connected to a compressed air system. This enables pressurized air to be supplied to the inlet of the nozzle 12. The nozzle 12 has an operator lever 16 which, when squeezed toward the main body of the valve, opens an internal valve by an amount proportional to the movement of the lever. The opening of the valve controls the flow of pressurized air through the nozzle from the fitting 14 to an outlet end 18.

The Outlet end 18 is connected to a T fitting 22 which has a venturi tube 20 that is press fit inside fitting 22 to restrict (regulate) the flow of air through the nozzle 12. It should be understood that conventional compressed air systems within motor vehicle repair garages typically supply air at a relatively high pressure which must be reduced by the venturi tube in order that the mechanic is able to control the vacuum level produced by the present device. The air passing through the nozzle 12 enters the venturi tube 20 that has an inner passage 24 which narrows toward an outlet 26. As the air flows through the venturi, a negative pressure is produced in a vacuum outlet 28 of T fitting 22 due to the Bernoulli principle. An exhaust tube 46 is connected to outlet 26 to enhance the vacuum produced at outlet 28. Safety relief holes 48 in exhaust tube 46 prevent positive pressure on gauge 42 due to blockage of exhaust tube 46.

An isolation valve 30 is connected to the vacuum outlet 28 of the T fitting 22 and to the first port 34 of T fitting 38. The T fitting 38 has a second port 36 to which a vacuum gauge 42 is connected and a third port 40 to which a barbed fitting 44 is connected for attaching a vacuum hose. The valve 30 is operated by a manual lever 32 to close communication between the vacuum outlet 28 and the ports for the vacuum gage 42 and hose fitting 44.

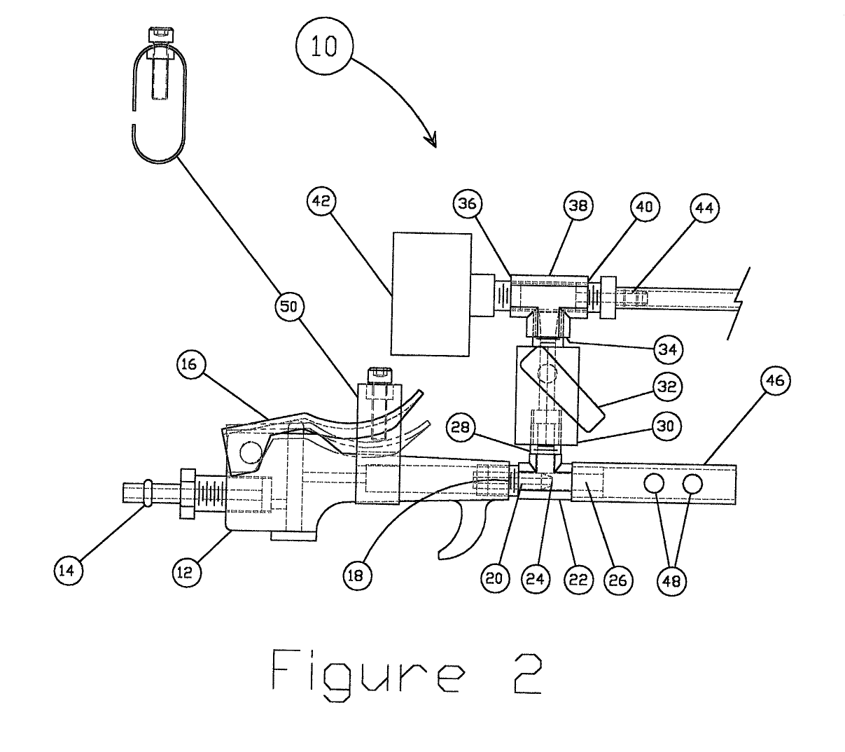

FIG. 2—Additional Embodiments

Additional embodiments are shown in FIG. 2; a thumbscrew clamp 50 mounted over operator lever 16 to lock lever in open position to allow hands free operation.

Operation

To use the vacuum source diagnostic tool 10, a mechanic couples a compressed air source to quick disconnect inlet 14 and a hose between the barbed fitting 44 and a component on the motor vehicle that is to be tested. The valve 30 is placed in the open position. The mechanic then operates the lever 16 to allow compressed air to flow through the nozzle 12, into the venturi 20 and out from outlet 26. This produces a negative pressure at the vacuum outlet 28 of the T fitting 22 which draws air through the valve 30 from the hose on fitting 44. This creates a negative pressure at the motor vehicle component being tested. The amount of the partial vacuum is indicated by the vacuum gauge 42.

By regulating the flow of compressed air through the nozzle 12, the amount of vacuum produced at fitting 44 can be controlled while observing the dial of the vacuum gauge 42. When the proper level of vacuum has been produced for activating the motor vehicle component, the mechanic uses another hand to close the valve 30 by operating lever 32. Thereafter, the mechanic can release the lever 16 of the compressed air nozzle 12 as the partial vacuum is maintained by the closure of valve 30. At this point, a constant vacuum is being applied to the component of the motor vehicle being tested.

The mechanic also is able to observe whether there is leak at the component under test by observing whether the partial vacuum level indicated by gauge 42 changes while the manual valve 30 is closed. The vacuum applied to motor vehicle component can be released by the mechanic once again by opening the manual valve 30.

Advantages

The vacuum source diagnostic tool 10 has a minimum number of moving components, and those components are commonly available in relatively long life forms. Thus, the present tool which utilizes compressed air to create the vacuum in a venturi 20 is an improvement over commonly available hand-operated vacuum pumps for motor vehicle diagnostic purposes.

### CONCLUSION, RAMIFICATIONS AND SCOPE

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Vacuum Source Diagnostic Tool for Motor Vehicles comprising:
A main control valve (nozzle);
A quick disconnect male fitting;
An operator lever providing variable control of air intake and vacuum;
A special T adapter with venturi press fit inside;
A specially designed exhaust tube that enhances the vacuum by creating resistance;
Safety relief holes in exhaust tube to prevent positive pressure on gauge;
An isolation valve;
A standard T fitting providing a vacuum port and an interface to the vacuum gauge;
A vacuum gauge;
A vacuum port consisting of a barbed fitting; and
A manual lever for opening and closing isolation valve.
